(19) United States
(12) Patent Application Publication
(10) Pub. No.: US 2011/0035137 A1
(43) Pub. Date: Feb. 10, 2011

(54) VEHICLE OPERATION DIAGNOSTIC DEVICE, VEHICLE OPERATION DIAGNOSTIC METHOD, AND COMPUTER PROGRAM

(75) Inventors: Teru KONISHI, Okazaki (JP); Kanako Nishita, Okazaki (JP); Yusuke Ueno, Nagoya (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-shi (JP)

(21) Appl. No.: 12/842,603

(22) Filed: Jul. 23, 2010

(30) Foreign Application Priority Data
Aug. 7, 2009 (JP) 2009-184092

(51) Int. Cl. F02D 28/00; G05D 1/00

(52) U.S. Cl. 701/115; 701/103

(57) ABSTRACT

Vehicle operation diagnostic devices, methods, and programs detect an idling stop of a vehicle. The devices, methods, and programs acquire a fuel consumption required for an engine of the vehicle to start, and acquire, if the idling stop is detected, an amount of fuel consumed if idling were to be continued during a period in which the idling stop is performed. The devices, methods, and programs determine whether a fuel consumption reduction effect is obtained based on the engine-start fuel consumption and the fuel consumption if idling were to be continued, and provide guidance based on the determination of whether the fuel consumption reduction effect is obtained.

### INCORPORATION BY REFERENCE

The disclosure of Japanese Patent Application No. 2009-184092, filed on Aug. 7, 2009, including the specification, drawings, and abstract is incorporated herein by reference in its entirety.

### BACKGROUND

1. Related Technical Fields

Related technical fields include vehicle operation diagnostic devices that diagnose an operation related to an idling stop of a vehicle, vehicle operation diagnostic methods, and vehicle operation diagnostic computer programs.

2. Related Art

Recently, in order to increase drivers' awareness of environmental issues and promote more environmentally-friendly driving, there is a system that diagnoses whether a vehicle operation performed by the driver during travel is appropriate in consideration of the environment. Here, an idling stop is a state in which the engine is stopped during idling as the driver waits for a traffic signal to turn green or the like. In addition to reducing emissions discharged from the vehicle, an idling stop can also reduce the amount of gasoline consumed. Therefore, the idling stop is an important vehicle operation from an environmental standpoint.

Japanese Patent Application Publication No, JP-A-2005-222417 (pages 11 and 12, FIG. 13) describes a system that assigns points when the vehicle performs an idling stop at a point (such as an intersection or a rail crossing) where performing an idling stop is preferred, and evaluates a vehicle operation that considers the driver's environment.

### SUMMARY

However, in the system described in JP-A-2005-222417, a determination regarding whether an effect of less fuel consumption has actually been achieved by an idling stop is not used as evaluation criteria. The fuel consumption per unit time when starting the engine is known to be higher than the fuel consumption per unit time when continuously driving the engine. In other words, sometimes the amount of fuel required for restarting the engine from an idling stop state is larger than the reduced fuel consumption during an idling stop. In such cases, the effect of less fuel consumption cannot be obtained even if an idling stop is performed.

Thus, in the system described in JP-A-2005-222417, a vehicle operation performed by the driver may be evaluated as environmentally appropriate even when the effect of less fuel consumption is not achieved by performing the idling stop. Consequently, it is not possible to correctly evaluate whether the vehicle operation performed by the driver is environmentally appropriate.

Exemplary implementations of the broad inventive principles described herein correctly evaluate whether a vehicle operation performed by a driver is environmentally appropriate by taking into consideration whether an effect of less fuel consumption was obtained by performing an idling stop.

Exemplary implementations provide vehicle operation diagnostic devices, methods, and programs that detect an idling stop of a vehicle. The devices, methods, and programs acquire a fuel consumption required for an engine of the vehicle to start, and acquire, if the idling stop is detected, an amount of fuel consumed if idling were to be continued during a period in which the idling stop is performed. The devices, methods, and programs determine whether a fuel consumption reduction effect is obtained based on the engine-start fuel consumption and the fuel consumption if idling were to be continued, and provide guidance based on the determination of whether the fuel consumption reduction effect is obtained.

### BRIEF DESCRIPTION OF THE DRAWINGS

FIG. 1 is a block diagram that shows a navigation device according to an example;

FIG. 2 is a schematic diagram that shows a storage area of a non-reduction position storage database;

FIG. 3 is a flowchart of a vehicle operation diagnostic method according to the example;

FIG. 4 is a drawing that shows an example of guidance regarding an effective idling stop time by the navigation device;

FIG. 5 is a flowchart of a tentative fuel consumption acquisition method according to the example;

FIG. 6 is a flowchart of an idling stop determination method according to the example; and

FIG. 7 is a drawing that shows an example of guidance regarding the effective idling stop time by the navigation device.

### DETAILED DESCRIPTION OF EXEMPLARY IMPLEMENTATIONS

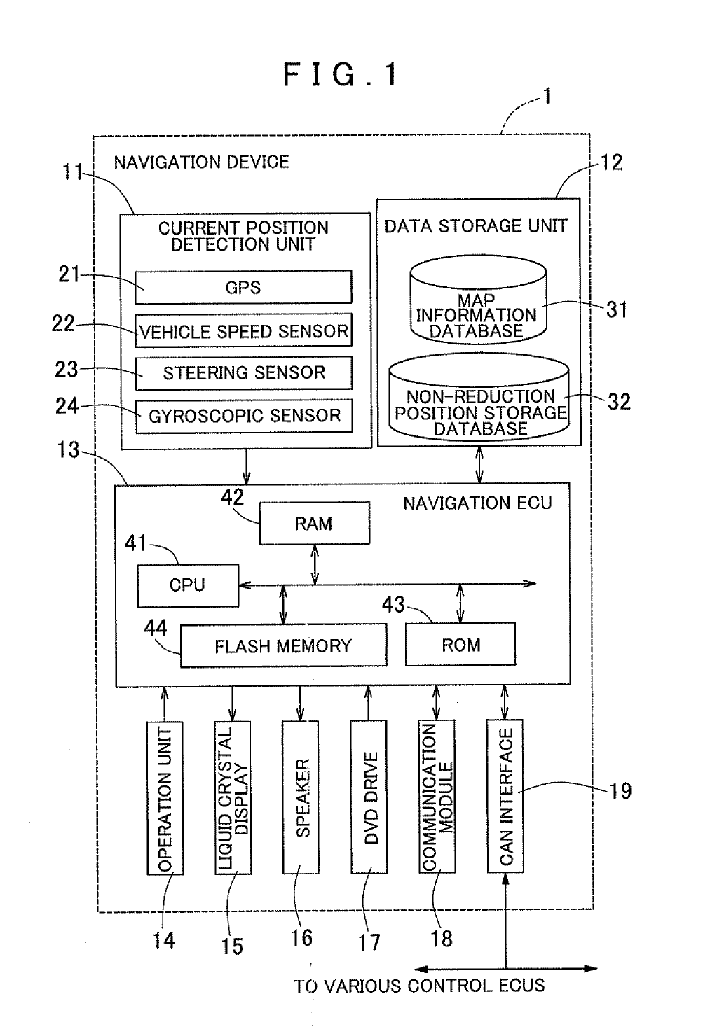

A specific example of a vehicle operation diagnostic device that is realized in a navigation device will be described in detail below with reference to the drawings. First, an overall configuration of a navigation device 1 according to the present example will be explained using FIG. 1. FIG. 1 is a block diagram that shows the navigation device 1 according to the present example.

As shown in FIG. 1, the navigation device 1 according to the present example is constituted by a current position detection unit 11 that detects a current vehicle position; a data storage unit 12 that stores various data; a controller (e.g., navigation electronic control unit (ECU) 13) that performs various computational processing based on input information; an operation unit 14 that accepts an operation from the user; a liquid crystal display 15 that displays for the user a map, various information related to guidance regarding a diagnostic result from diagnosing a vehicle operation performed by the driver, and the like; a speaker 16 that outputs voice guidance related to route guidance; a DVD drive 17 that reads a DVD serving as a storage medium that stores programs; a communication module 18 that performs communication with an information center such as a traffic information center; and a controller area network (CAN) interface 19.

Each of the configuring elements of the navigation device 1 will be explained in order below.

The current position detection unit 11 includes a GPS 21, a vehicle speed sensor 22, a steering sensor 23, a gyroscopic sensor 24, an altimeter (not shown in the drawing), and the like, and is capable of detecting the vehicle's current position, heading, running speed, and the like. The vehicle speed sensor 22, in particular, is a sensor for detecting the vehicle's speed and distance traveled. The vehicle speed sensor 22 generates a pulse in response to the rotation of the vehicle's wheels and outputs a pulse signal to the navigation ECU 13. The navigation ECU 13 counts the generated pulses to compute the revolution speed of the wheels and the distance traveled. Note that it is not necessary for the navigation device 1 to be provided with all of the four types of sensors described above, and it is acceptable for the navigation device 1 to be provided with only one or a plurality among the four types of sensors.

The data storage unit 12 includes a hard disk (not shown in the drawing) serving as an external storage device and recording medium, and a read/write head (not shown in the drawing) serving as a drive for reading a map information database 31, a non-reduction position storage database 32, predetermined programs, and so on from the hard disk and writing predetermined data to the hard disk.

The map information database 31 stores various types of map data that are necessary for route guidance, traffic information guidance, and map displays.

Specifically, the map data includes link data that pertains to the shapes of roads (links), node data that pertains to node points, POI data that pertains to points such as facilities, intersection data that pertains to various intersections, search data for finding routes, search data for finding geographical points, and image drawing data for drawing images of maps, roads, traffic information, and the like on the liquid crystal display 15.

Note that the map information database 31 is updated based on update data provided through a storage medium (such as a DVD or a memory card) or update data distributed from a map distribution center or the like.

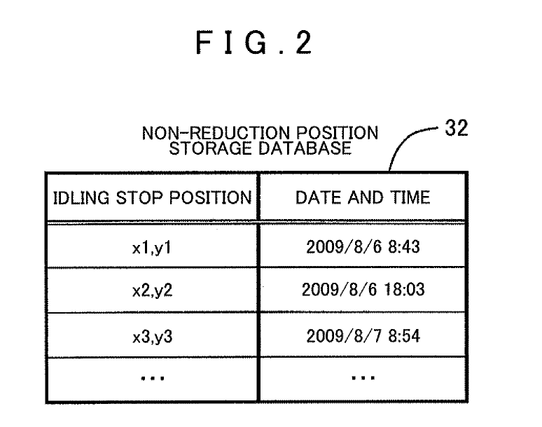

The non-reduction position storage database 32 is a storage unit that cumulatively stores vehicle positions at which an idling stop was performed or the like, when the navigation ECU 13 determines that a fuel consumption reduction effect was not obtained by the vehicle performing the idling stop. For example, FIG. 2 is a drawing that shows an example of a storage area of the non-reduction position storage database 32. As shown in FIG. 2, the non-reduction position storage database 32 stores position coordinates at which idling stops were performed and determined as not obtaining a fuel consumption reduction effect, and the dates and times when the idling stops were performed.

The navigation ECU 13 provides guidance related to the idling stop when the vehicle arrives at a position stored in the non-reduction position storage database 32 as described later. Note that the determination regarding whether a fuel consumption reduction effect was obtained by performing the idling stop will be explained in detail later.

Further note that, here, “idling” refers to a state in which the vehicle is stopped with the engine still turned on, whereas an “idling stop” refers to a state in which the engine is turned off during idling.

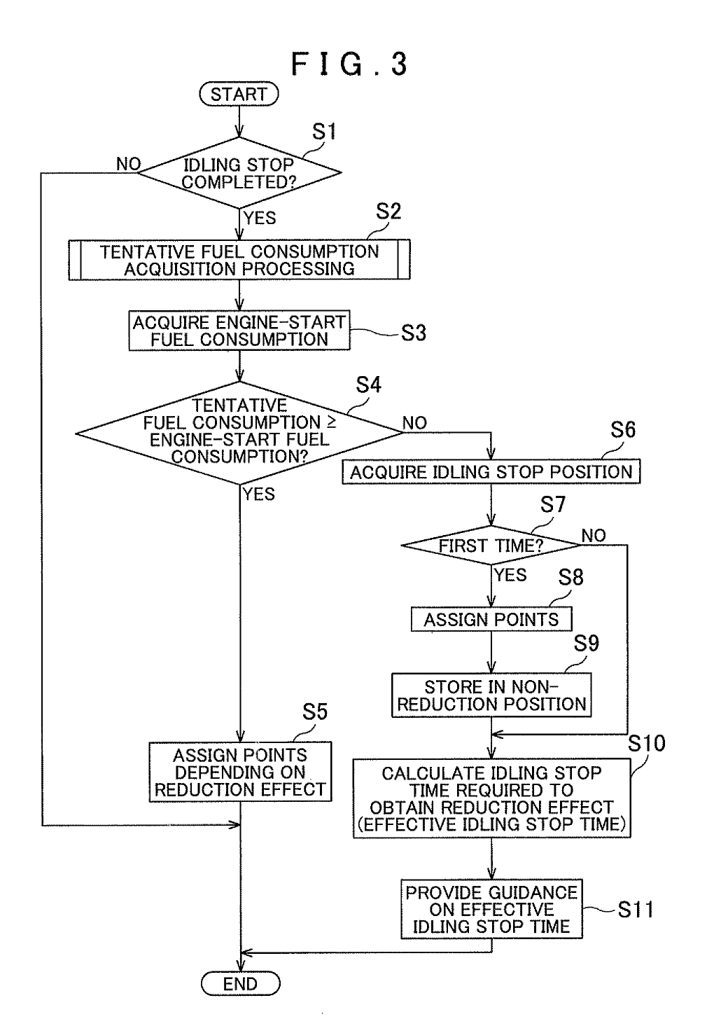

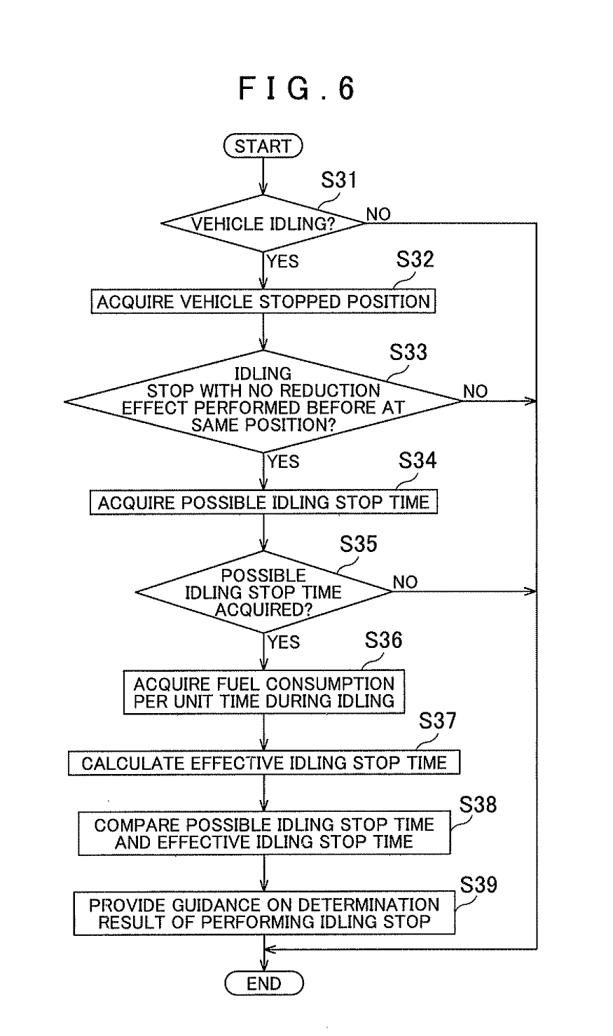

The navigation ECU 13 is an electronic control unit that performs overall control of the navigation device 1, including guidance route setting processing that sets a guidance route from the current position to a destination when a destination has been selected, vehicle operation diagnostic processing that diagnoses whether an operation related to an idling stop performed by the driver is environmentally appropriate, and idling stop guidance processing that provides guidance regarding whether the vehicle should perform an idling stop. The navigation ECU 13 has a CPU 41 serving as a computational device and a control device; a RAM 42 which is used as a working memory when the CPU 41 performs various types of computational processing, and also stores route data and the like when a route has been found; a ROM 43 storing control programs as well as a vehicle operation diagnostic processing program (see FIG. 3) and an idling stop determination processing program (see FIG. 6); and an internal storage device such as a flash memory 44 for storing programs read from the ROM 43.

The operation unit 14 is operated at times such as when a place of departure is input as a travel start point and a destination is input as a travel end point, and includes a plurality of operation switches (not shown in the drawing), such as various types of keys, buttons, and the like. Based on switch signals that are output by operating the various operation switches, such as by pressing or the like, the navigation ECU 13 controls the various types of corresponding operations that are executed. Note that the operation unit 14 can also be configured as a touch panel that is provided on the front surface of the liquid crystal display 15.

The liquid crystal display 15 displays a map image that includes roads, traffic information, operation guidance, an operation menu, key guidance, a guidance route from the place of departure to the destination, guidance information along the guidance route, news, a weather forecast, the time, e-mail, a television program, and the like. A diagnostic result after performing a diagnosis of an operation related to an idling stop performed by the driver is also displayed.

The speaker 16 outputs traffic information guidance and voice guidance for guiding travel along the guidance route on the basis of an instruction from the navigation ECU 13. Voice guidance for a diagnostic result after performing a diagnosis of an operation related to an idling stop performed by the driver is also output.

The DVD drive 17 is a drive capable of reading data stored on a recording medium such as a DVD or a CD. The map information database 31 is updated and the like based on the data that is read.

The communication module 18 is a communication device, such as a mobile telephone or a DCM, for example, that receives traffic information that is transmitted from a traffic information center, such as the Vehicle Information and Communication System (VICS®) center, a probe center, or the like, for example. The traffic information includes various types of information, such as congestion information, regulatory information, and traffic accident information.

In the present example, information pertaining to the lighting mode of a traffic signal installed on the road and the operation status of a crossing gate installed at a rail crossing is also received from an information center or the like through the communication module 18.

The CAN interface 19 is an interface that inputs and outputs data to and from a CAN, which is an on-vehicle network standard according to which multiplex communication between various control ECUs installed in the vehicle is performed. Through the CAN, the navigation ECU 13 is intercommunicably connected to the various control ECUs that control the vehicle (e.g. a brake control ECU, an engine control ECU, and a front camera control ECU). The navigation ECU 13 also diagnoses a vehicle operation performed by the driver, as described later, based on various types of data acquired from the various control ECUs through the CAN (such as a braking amount, an engine driving condition, remaining fuel, a coolant temperature, an engine temperature, a lighting mode of a traffic signal, an operation status of a crossing gate, and the like).

Next, an exemplary vehicle operation diagnostic processing method will be described with respect to the algorithm shown in FIG. 3. The exemplary method may be implemented, for example, by one or more components of the above-described navigation device 1. For example, the exemplary algorithm may be implemented as one or more computer programs stored in stored in the RAM 42, the ROM 43, or the like provided in the navigation ECU 13, and may be executed by the CPU 41. Here, the vehicle operation diagnostic processing program is executed at a predetermined time interval (e.g. every 200 ms) once the vehicle power is turned on, and is a program that diagnoses whether an operation related to an idling stop performed by the vehicle is environmentally appropriate.

In the vehicle operation diagnostic processing program, first, at step (abbreviated to “S” below) 1, the CPU 41 determines whether the vehicle has completed performing an idling stop (that is, whether an idling stop was performed and the engine subsequently started). Specifically, based on the current vehicle position detected by the current position detection unit 11, the detection result of the vehicle speed sensor 22, the engine driving condition acquired through the CAN, and the like, the CPU 41 (1) detects that the vehicle speed is zero, (2) detects that the engine has been subsequently stopped, and (3) determines that the vehicle has completed performing an idling stop when it is detected thereafter that the engine has been restarted.

If it is determined that the vehicle has completed performing an idling stop (S1: YES), then the routine proceeds to S2. However, if it is determined that the vehicle has not completed performing an idling stop (S1: NO), then the vehicle operation diagnostic processing program is ended.

Next, at S2, the CPU 41 executes a tentative fuel consumption acquisition process (FIG. 5) that will be described later. Here, the tentative fuel consumption acquisition process acquires an amount of fuel consumption under the assumption that idling is continued during the period in which the idling stop is performed, that is a reduced fuel consumption (hereinafter referred to as a “tentative fuel consumption”) compared to an amount of fuel that is consumed when idling is continued.

At S3, the CPU 41 acquires an amount of fuel consumption (hereinafter referred to as an “engine-start fuel consumption”) that is required for starting the engine after the vehicle has performed an idling stop. Note that the engine-start fuel consumption is acquired based on a fuel difference before and after the engine is started, which is acquired through the CAN. Further note that the engine-start fuel consumption may use a fixed value that is set per vehicle model.

Then, at S4, the CPU 41 compares the tentative fuel consumption acquired at S2 and the engine-start fuel consumption acquired at S3. Based on this comparison, the CPU 41 determines whether the tentative fuel consumption is equal to or greater than the engine-start fuel consumption, that is, whether a fuel consumption reduction effect has been obtained by the vehicle performing the idling stop compared to continuing idling.

If it is determined that the tentative fuel consumption is equal to or greater than the engine-start fuel consumption (S4: YES), that is, if it is determined that a fuel consumption reduction effect has been obtained by the vehicle performing the idling stop compared to continuing idling, the routine proceeds to S5. However, if it is determined that the tentative fuel consumption is less than the engine-start fuel consumption (S4: NO), that is, if it is determined that a fuel consumption reduction effect has not been obtained by the vehicle performing the idling stop compared to continuing idling, the routine proceeds to S6.

Next, at S5, which is executed when there is a diagnosis that a fuel consumption reduction effect has been obtained by the vehicle performing the idling stop compared to continuing idling, the CPU 41 assigns points to the user in accordance with the reduction effect. Here, the assigned points are used to evaluate the driver's degree of environmental contribution. Specifically, at S5, the CPU 41 uses the liquid crystal display 15 and/or the speaker 16 to provide guidance regarding the assigned number of points. Note that the assigned number of points is cumulatively added, and the current cumulative value is stored in the RAM 42 or the like. In addition, if the user performs a prescribed operation, guidance is provided using the liquid crystal display 15 and/or the speaker 16 regarding the current cumulative value. For the number of points assigned at S5, a greater number of points is preferably assigned for a larger fuel consumption reduction effect obtained by performing the idling stop.

The navigation device 1 then provides the user with advice related to a vehicle operation in a form that is based on the cumulative value of the current number of points during normal driving of the vehicle. For example, if the cumulative value of the number of points is less than a prescribed value, advice suggesting that the user drive in a more environmentally-friendly manner is provided a greater number of times.

Meanwhile, at S6, which is executed when there is a diagnosis that a fuel consumption reduction effect has not been obtained by the vehicle performing the idling stop compared to continuing idling, the CPU 41 first uses the current position detection unit 11 to acquire the vehicle position at which the idling stop was performed (i.e., the current vehicle position).

Next, at S7, the CPU 41 reads the position data stored in the non-reduction position storage database 32, and determines whether coordinates for the same position as the vehicle position at which the idling stop was performed, which was acquired at S6, are already stored. Namely, the CPU 41 determines whether this is the first time a fuel consumption reduction effect was not obtained at this idling stop position.

If it is determined that this is the first time a fuel consumption reduction effect was not obtained at this idling stop position (S7: YES), then the routine proceeds to S8. However, if it is determined that this is not the first time a fuel consumption reduction effect was not obtained at this idling stop position (S7: NO), then the routine proceeds to S10.

At S8, the CPU 41 makes a diagnosis that a fuel consumption reduction effect has not been obtained by the vehicle performing the idling stop compared to continuing idling, and assigns points to the user. Here, similar to S5, the assigned points are used to evaluate the driver's degree of environmental contribution. However, the assigned number of points is preferably less compared to S5. For example, the assigned number of points at S8 may be half of the lowest number of points assigned at S5. Thus, points can be suitably assigned to the user's driving operation. Based on the point cumulative value, advice can then be suitably provided.

Next, at S9, the CPU 41 stores in the non-reduction position storage database 32 (see FIG. 2) data for the vehicle position coordinates at which the idling stop was performed, which was acquired at S6, as data for idling stop position coordinates where a fuel consumption reduction effect was determined as not obtained.

At S10, the CPU 41 calculates an idling stop time (hereinafter referred to as an “effective idling stop time”) for the idling stop performed this time, which is required for obtaining a fuel consumption reduction effect compared to when idling is continued. Specifically, based on a fuel consumption per unit time of the vehicle immediately before the idling stop is performed and the engine-start fuel consumption acquired at S3, the CPU 41 calculates an idling stop time required to fulfill the condition of the tentative fuel consumption being equal to or greater than the engine-start fuel consumption as the effective idling stop time. More specifically, the effective idling stop time is calculated using Equation 1 below.

$$T \geq \frac{S}{A} \qquad ( 1 )$$

where,

T=effective idling stop time,

S=engine-start fuel consumption, and

A=fuel consumption per unit time immediately before performing the idling stop.

Next, at S11, the CPU 41 provides guidance regarding the effective idling stop time calculated at S10. Specifically, guidance for the effective idling stop time is displayed on the liquid crystal display 15 and/or output by voice using the speaker 16.

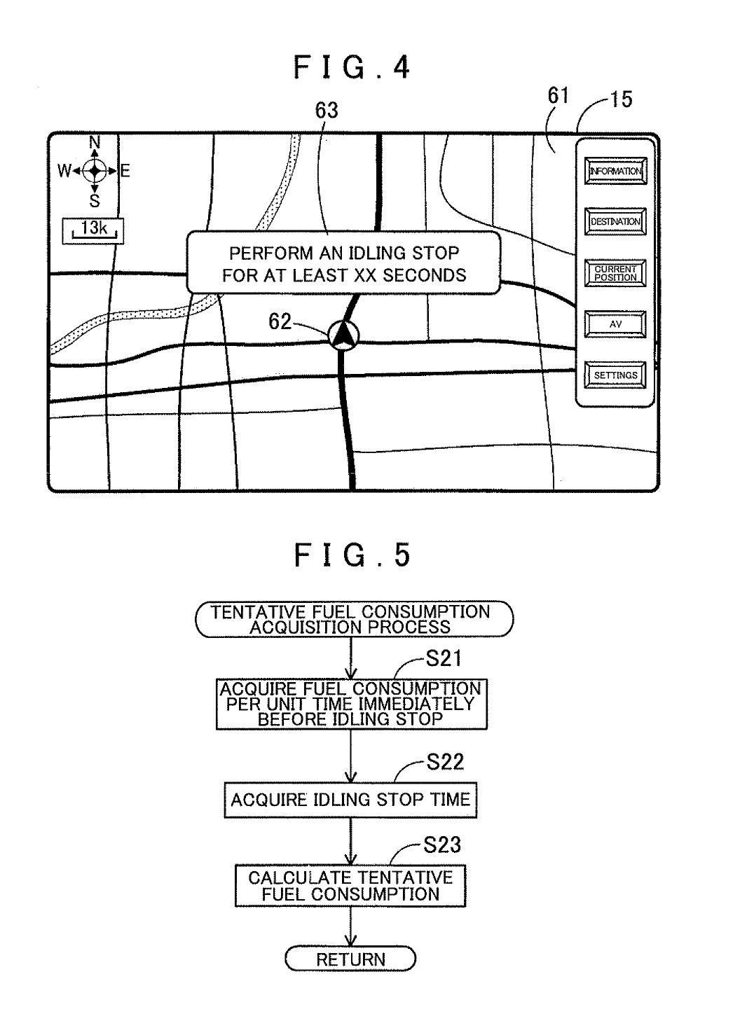

FIG. 4 is a drawing that shows a guidance screen 61 that is displayed on the liquid crystal display 15 of the navigation device 1 at S11. As shown in FIG. 4, in addition to a map image of the vehicle surroundings, a vehicle position mark 62 that indicates the vehicle position and an advice window 63 are displayed on the guidance screen 61. The advice window 63 shows text that provides guidance regarding the effective idling stop time calculated at S10. For example, in the example shown in FIG. 4, the text “Perform an idling stop for at least XX seconds” is displayed.

By referring to the guidance screen 61, the user can know that the idling stop performed this time did not obtain a fuel consumption reduction effect and also know the effective idling stop time required for obtaining a fuel consumption reduction effect.

Next, a sub-processing method/program of the tentative fuel consumption acquisition process executed at S2 will be explained based on the algorithm in FIG. 5.

First, at S21, the CPU 41 acquires a fuel consumption per unit time of the vehicle immediately before performing the idling stop (hereinafter referred to as a “unit fuel consumption”) using the CAN or the like.

Next, at S22, the CPU 41 acquires a period during which the vehicle performed the idling stop (hereinafter referred to as an “idling stop period”). Specifically, the CPU 41 uses a timer or the like to measure the amount of time passed from detection of the start of the idling stop to detection of the completion of the idling stop.

At S23, based on the unit fuel consumption acquired at S21 and the idling stop period acquired at S22, the CPU 41 then calculates the tentative fuel consumption under the assumption that idling is continued during the period in which the idling stop is performed. Specifically, the tentative fuel consumption is calculated using Equation 2 below.

X=M×Y (2)

where,

X=tentative fuel consumption,

M=unit fuel consumption, and

Y=idling stop period.

The processing at S3 onward is then executed using the tentative fuel consumption calculated at S23.

Next, an exemplary idling stop determination processing method will be described based on the algorithm shown in FIG. 6. The exemplary method may be implemented, for example, by one or more components of the navigation device 1. For example, the exemplary algorithm may be implemented as one or more computer programs stored in stored in the RAM 42, the ROM 43, or the like provided in the navigation ECU 13, and may be executed by the CPU 41. Here, the idling stop determination processing program is executed at a predetermined time interval (e.g. every 200 ms) once the vehicle power is turned on, and is a program that provides guidance on whether the vehicle should perform an idling stop.

In the idling stop determination processing program, first, at S31, the CPU 41 determines whether the vehicle is idling based on information acquired from the CAN and the detection result of the vehicle speed sensor 22.

If it is determined that the vehicle is idling (S31: YES), then the routine proceeds to S32. However, if it is determined that the vehicle is not idling (S31: NO), then the idling stop determination processing program is ended.

At S32, the CPU 41 uses the current position detection unit 11 to acquire the stopped position of the vehicle (i.e., the current vehicle position).

Next, at S33, the CPU 41 reads the position data stored in the non-reduction position storage database 32, and determines whether coordinates for the same position as the vehicle stopped position acquired at S32 are already stored. Namely, the CPU 41 determines whether the vehicle is idling at a position where the vehicle performed an idling stop before and where the vehicle operation diagnostic processing program (FIG. 3) made a diagnosis that a fuel consumption reduction effect was not obtained.

If it is determined that coordinates for the same position as the vehicle stopped position are already stored in the non-reduction position storage database 32 (S33: YES), that is, if it is determined that the vehicle is idling at a position where the vehicle performed an idling stop before and where the vehicle operation diagnostic processing program made a diagnosis that a fuel consumption reduction effect was not obtained, the routine proceeds to S34. However, if it is determined that coordinates for the same position as the vehicle stopped position are not already stored in the non-reduction position storage database 32 (S33: NO), that is, if it is determined that the vehicle is not idling at a position where the vehicle performed an idling stop before and where the vehicle operation diagnostic processing program made a diagnosis that a fuel consumption reduction effect was not obtained, the idling stop determination processing program is ended.

Next, at S34, the CPU 41 acquires a time during which the idling vehicle can perform the idling stop (hereinafter referred to as a “possible idling stop time”).

Specifically, first, the CPU 41 determines the cause of the vehicle stopping based on an image taken by a front camera installed at the front of the vehicle, which was acquired through the CAN. If it is consequently determined that the vehicle is stopped due to a red traffic light, for example, the CPU 41 receives information related to the lighting mode of the traffic signal from an information center or the like through the communication module 18, and specifies a time until the traffic signal turns green. The specified time is thus acquired as the possible idling stop time.

Alternatively, if it is determined that the vehicle is stopped due to the operation of a crossing gate at a rail crossing, for example, the CPU 41 receives information related to the operation status of the crossing gate from an information center or the like through the communication module 18, and specifies a time until the crossing gate is raised. The specified time is thus acquired as the possible idling stop time.

Next, at S35, the CPU 41 determines whether the possible idling stop time has been acquired at S34. If it is determined that the possible idling stop time has been acquired (S35: YES), then the routine proceeds to S36. However, if it is determined that the possible idling stop time has not been acquired (S35: NO), the idling stop determination processing program is ended without providing guidance.

At S36, the CPU 41 acquires a fuel consumption per unit time during idling until the vehicle starts traveling (hereinafter referred to as a “unit estimated fuel consumption”) from the current fuel consumption per unit time of the vehicle. Specifically, the CPU 41 assumes that the vehicle fuel consumption per unit time during idling will not change, and acquires the current vehicle fuel consumption per unit time as the unit estimated fuel consumption.

At S37, the CPU 41 calculates an idling stop time (hereinafter referred to as an “effective idling stop time”), which is required for obtaining a fuel consumption reduction effect by the idling vehicle performing the idling stop compared to continuing idling. Specifically, based on the unit estimated fuel consumption acquired at S36 and an estimated engine-start fuel consumption required for the engine of the vehicle to start, the CPU 41 calculates an idling stop time required to fulfill the condition of the tentative fuel consumption being equal to or greater than the engine-start fuel consumption as the effective idling stop time. More specifically, the effective idling stop time is calculated using Equation 3 below.

$$T \geq \frac{{S}^{′}}{{A}^{′}} \qquad ( 3 )$$

where,

T=effective idling stop time,

S′=estimated engine-start fuel consumption, and

A′=unit estimated fuel consumption.

Note that the estimated engine-start fuel consumption required for the engine of the vehicle to start is calculated from a past history and acquired as a fixed value.

Next, at S38, the CPU 41 compares the possible idling stop time acquired at S34 and the effective idling stop time calculated at S37. If the CPU 41 determines that the possible idling stop time is equal to or greater than the effective idling stop time, the CPU 41 makes a diagnosis that performing the idling stop in the vehicle is the environmentally appropriate vehicle operation. However, if the CPU 41 determines that the possible idling stop time is less than the effective idling stop time, the CPU 41 makes a diagnosis that not performing the idling stop in the vehicle is the environmentally appropriate vehicle operation.

At S39, the CPU 41 provides guidance regarding whether the vehicle should perform the idling stop based on the comparison result at S38. Specifically, if it is determined at S38 that the possible idling stop time is equal to or greater than the effective idling stop time, performing the idling stop in the vehicle is diagnosed as the environmentally appropriate vehicle operation. Accordingly, guidance that recommends performing the idling stop is displayed on the liquid crystal display 15 and/or output by voice using the speaker 16. However, if it is determined at S38 that the possible idling stop time is less than the effective idling stop time, not performing the idling stop in the vehicle is diagnosed as the environmentally appropriate vehicle operation. Accordingly, guidance that recommends not performing the idling stop is displayed on the liquid crystal display 15 and/or output by voice using the speaker 16.

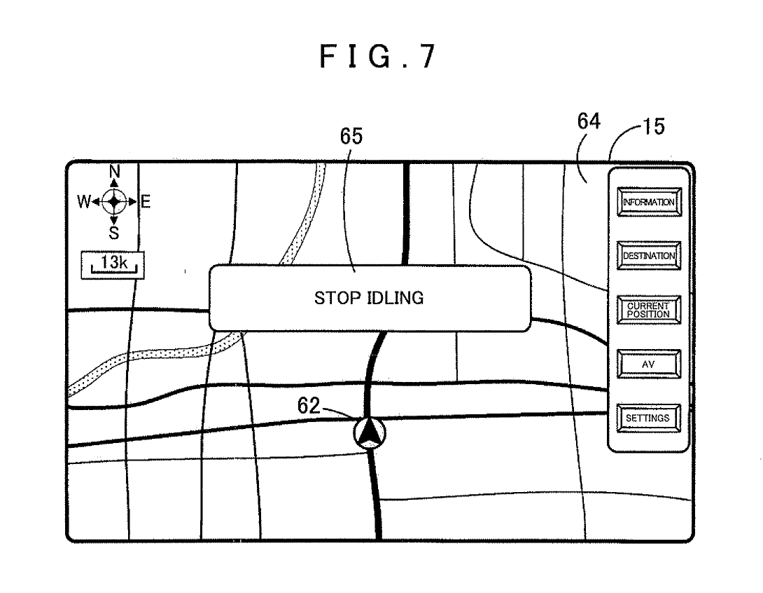

FIG. 7 is a drawing that shows a guidance screen 64 that is displayed on the liquid crystal display 15 of the navigation device 1 at S39. As shown in FIG. 7, in addition to a map image of the vehicle surroundings, the vehicle position mark 62 that indicates the vehicle position and an advice window 65 are displayed on the guidance screen 64. The advice window 65 shows text that provides guidance recommending that the idling stop be performed or not performed based on the comparison result at S38. The example shown in FIG. 7 is the guidance screen 64 displayed when a diagnosis is made that performing the idling stop in the vehicle is the environmentally appropriate vehicle operation, and the text “Stop idling” is displayed on the advice window 65.

By referring to the guidance screen 64, the user can know whether idling should be stopped.

As described in detail above, in the navigation device 1 according to the present example, a vehicle operation diagnostic method performed by the navigation device 1, and a computer program executed by the navigation ECU 13 of the navigation device 1, if the vehicle has performed an idling stop, the tentative fuel consumption is acquired that is an amount of fuel consumed during the period in which the idling stop was performed (S2). The engine-start fuel consumption that is an amount of fuel required for the engine of the vehicle to start is also acquired (S3). By comparing the acquired engine-start fuel consumption and the tentative fuel consumption, it is determined whether a fuel consumption reduction effect has been obtained by the vehicle performing the idling stop compared to continuing idling (S4). Guidance is then provided based on the determination result (S5, S8 to S11). Therefore, the driver's vehicle operation related to the idling stop can be evaluated in consideration of whether a fuel consumption reduction effect has been obtained by performing the idling stop. Thus, it is possible to correctly evaluate whether the vehicle operation performed by the driver is environmentally appropriate.

In addition, a value found by multiplying the stop period, during which the vehicle performed the idling stop, and the unit fuel consumption, which is the vehicle fuel consumption per unit time, is acquired as the tentative fuel consumption (S23). Therefore, even if the idling stop is performed in the vehicle, the fuel consumption during idling without the idling stop can be accurately calculated, making it possible to accurately determine whether a fuel consumption reduction effect was obtained. Thus, it is possible to correctly evaluate whether the vehicle operation performed by the driver is environmentally appropriate.

At a position where a fuel consumption reduction effect was not obtained before by the vehicle performing the idling stop, guidance related to the idling stop is provided when the vehicle arrives at the same position again (S39). Therefore, guidance related to the idling stop can be provided at a position where such guidance is needed, and the driver can be encouraged to perform an operation related to an idling stop that is environmentally appropriate.

Further, guidance is provided based on the result of comparing the effective idling stop time and the possible idling stop time in a situation where the vehicle is idling and able to perform an idling stop (S39). Therefore, the vehicle can be made to perform an operation related to an idling stop that is environmentally appropriate.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, when calculating the effective idling stop time at S37 in the present example, the current fuel consumption per unit time of the vehicle was used in the above Equation 3 to calculate the effective idling stop time. However, the effective idling stop time may also be a fixed value that is set per vehicle model. The fixed value may further be a value that changes depending on the season. In addition, a past vehicle travel history and fuel consumption history may be used to calculate the effective idling stop time.

Application of the inventive principles described herein is not limited to a gasoline vehicle that uses a gasoline engine as a drive source; these principles may also be applied to an electric vehicle that uses a motor as a drive source, and a hybrid vehicle that uses both a gasoline engine and a motor as drive sources.

What is claimed is:

1. A vehicle operation diagnostic device, comprising:
a controller that is configured to:
detect an idling stop of a vehicle;
acquire an engine-start fuel consumption that is a fuel consumption required for an engine of the vehicle to start;
acquire, if the idling stop is detected, a tentative fuel consumption that is an amount of fuel consumed if idling were to be continued during a period in which the idling stop is performed;
determine whether a fuel consumption reduction effect is obtained based on the engine-start fuel consumption and the tentative fuel consumption; and
provide guidance based on the determination of whether the fuel consumption reduction effect is obtained.

2. The vehicle operation diagnostic device according to claim 1, wherein the controller is configured to:
acquire a stop period during which the idling stop of the vehicle is performed; and
acquire a unit fuel consumption that is a fuel consumption per unit time of the vehicle immediately before the idling stop of the vehicle is performed; and
calculate the tentative fuel consumption by multiplying the stop period and the unit fuel consumption.

3. The vehicle operation diagnostic device according to claim 1, further comprising:
a position storage unit;
wherein the controller is configured to:
acquire a position of the vehicle where the idling stop is performed; and
when it is determined that a fuel consumption reduction effect was not obtained, store the acquired position in the position storage unit.

4. The vehicle operation diagnostic device according to claim 3, wherein the controller is configured to:
detect an idling of the vehicle;
determine if a position of the detected idling is a position stored in the storage unit; and
if the detected idling position is stored in the storage unit:
acquire a possible idling stop time;
acquire a fuel consumption per unit time during the idling;
calculate an effective idling stop time based on the acquired fuel consumption per unit time and an estimated fuel consumption required for the engine to start;
compare the acquired possible idling stop time with the calculated idle stop time; and
if the possible idling stop time is greater than or equal to the effective idling stop time, provide guidance comprising a recommendation to perform an idling stop.

5. The vehicle operation diagnostic device according to claim 4, wherein the controller is configured to:
acquire an image from a front-mounted camera;
determine from the image the reason for the idling of the vehicle; and
acquire the possible idling stop time based on the determined reason for the idling of the vehicle.

6. The vehicle operation diagnostic device according to claim 1, wherein the controller detects the idling stop when a speed of the vehicle is zero and the engine of the vehicle has been stopped.

7. A vehicle operation diagnostic method, comprising:
detecting an idling stop of a vehicle;
acquiring an engine-start fuel consumption that is a fuel consumption required for an engine of the vehicle to start;
acquiring, if the idling stop is detected, a tentative fuel consumption that is an amount of fuel consumed if idling were to be continued during a period in which the idling stop is performed;
determining whether a fuel consumption reduction effect is obtained based on the engine-start fuel consumption and the tentative fuel consumption; and
providing guidance based on the determination of whether the fuel consumption reduction effect is obtained.

8. The vehicle operation diagnostic method according to claim 7, further comprising:
acquiring a stop period during which the idling stop of the vehicle is performed; and
acquiring a unit fuel consumption that is a fuel consumption per unit time of the vehicle immediately before the idling stop of the vehicle is performed; and
calculating the tentative fuel consumption by multiplying the stop period and the unit fuel consumption.

9. The vehicle operation diagnostic method according to claim 7, further comprising:
acquire a position of the vehicle where the idling stop is performed; and
when it is determined that a fuel consumption reduction effect was not obtained, storing the acquired position in a position storage unit.

10. The vehicle operation diagnostic method according to claim 9, further comprising:
detecting an idling of the vehicle;
determining if a position of the detected idling is a position stored in the storage unit; and
if the detected idling position is stored in the storage unit:
acquiring a possible idling stop time;
acquiring a fuel consumption per unit time during the idling;
calculating an effective idling stop time based on the acquired fuel consumption per unit time and an estimated fuel consumption required for the engine to start;
comparing the acquired possible idling stop time with the calculated idle stop time; and
if the possible idling stop time is greater than or equal to the effective idling stop time, providing guidance comprising a recommendation to perform an idling stop.

11. The vehicle operation diagnostic method according to claim 10, further comprising:
acquiring an image from a front-mounted camera;
determining from the image the reason for the idling of the vehicle; and
acquiring the possible idling stop time based on the determined reason for the idling of the vehicle.

12. The vehicle operation diagnostic method according to claim 7, further comprising detecting the idling stop when a speed of the vehicle is zero and the engine of the vehicle has been stopped.

13. A non-transitory computer-readable storage medium storing a computer-executable program for vehicle operation diagnostics, the program comprising:
instructions for detecting an idling stop of a vehicle;
instructions for acquiring an engine-start fuel consumption that is a fuel consumption required for an engine of the vehicle to start;
instructions for acquiring, if the idling stop is detected, a tentative fuel consumption that is an amount of fuel consumed if idling were to be continued during a period in which the idling stop is performed;
instructions for determining whether a fuel consumption reduction effect is obtained based on the engine-start fuel consumption and the tentative fuel consumption; and
instructions for providing guidance based on the determination of whether the fuel consumption reduction effect is obtained.
